(19) United States
(12) Patent Application Publication
(10) Pub. No.: US 2016/0170689 A1
(43) Pub. Date: Jun. 16, 2016

(54) SELECTIVELY SETTABLE MESSAGE ROUTING SYSTEM FOR JOB STATUS ON A MULTIFUNCTION DEVICE

(71) Applicant: Xerox Corporation, Norwalk, CT (US)

(72) Inventors: Mary Ann Sprague, Macedon, NY (US); Maryann Fuhrmann, Webster, NY (US)

(21) Appl. No.: 14/570,367

(22) Filed: Dec. 15, 2014

(51) Int. Cl. G06F 3/12

(52) U.S. Cl. CPC G06F 3/1207; G06F 3/1273; G06F 3/1259; G06Q 50/20

(57) ABSTRACT

Method and systems are disclosed for enabling a selectively settable message routing system for communicating a job message associated with an assigned job on a multifunction device to the device administrator. The system includes an administrator profile including a plurality of addressable message receiving devices for selective contact of the administrator to communicate the job message. A message routing processor recognized the job status relative to a set of predetermined factors corresponding to a stall or stoppage of workflow for the assigned job, wherein the processor routes the job message to selected ones of the message receiving devices in response to the recognized ones of the predetermined factors.

### TECHNICAL FIELD

The presently disclosed embodiments are directed to selectively settable message routing systems for expedited communications of a job status on a multifunction device and for facilitating a responsive action in response to the communicated status.

### BACKGROUND

The present disclosure has application to the process of scanning and assessing the attributes (e.g. test scores) of a student or group of students at selected times during their learning process and particularly relates to the assessment and evaluation of student attributes or progress in a structured classroom where a teacher is required to educate the students to a level of proficiency in various subject matters and at particular grade levels. Typically, in a grade level classroom, the teacher periodically gives the students printed form assessments or tests, as they have previously been referred to, in order to obtain an indication of the student(s) level(s) of proficiency in the subject matter of immediate interest.

Heretofore, where a teacher was responsible for a class having a relatively large number of students, the teacher typically passed out to all students a common assessment form. The assessments are distributed to the students who then mark their responses on the forms which are then gathered by the teacher and individually reviewed and evaluated or graded by the teacher.

Systems have been implemented for automatically scoring and recording detailed assessment results for students in a relatively large class, thereby eliminating the need for manually scoring, and entering the results of the evaluations in a record book or database, and eliminating the loss of critical data inherent in the practice of recording only total scores or percentages.

One such system is the Xerox® Ignite™ Educator Support Platform which also sends emails to teachers if a scanning or printing error occurs during the automated assessment processing, at the automated assessment tool (i.e., a multifunction device (MFD)). But if the teacher is away from the classroom computer, as often the case during a normal school day, the teacher does not receive the message about the scanner/print job in a timely manner. When the message is eventually seen on the classroom computer screen, the teacher must walk back to the multifunction device which is often not located in the classroom, creating a time challenge to get back to the MFD. These trips back and forth between the computer in the classroom and the multifunction device consume precious free time in a teacher's already busy day.

More particularly, the subject embodiments relate to a scanning solution that is often located in either a central location in or near the school office or at several locations within a school building, and most often the multifunction devices are not located close to classrooms. These locations are convenient to accommodate numerous teachers, but often inconvenient for teachers who are unable to leave their classroom during the school day except for short periods of time when their students are with other instructors. It is during these small slices of time that the teacher relies on to accomplish the many activities needed for the school curriculum, including making copies, talking to other teachers, eating lunch, providing additional curriculum support for individual students, and meetings. It is also during these times that the teacher may take a stack of assessments that were recently completed by students and go to the nearest multifunction device to scan the sheets. The teacher will typically begin the scanning job and then leave to do another task.

If successful, the scanned documents are processed and an email is sent to the teacher for later validation. However, if problems occur with the scan, or students were noted as missing and did not take the assessment with the class, a message is sent to the teacher's email. The teacher then learns about the problem only after returning to the classroom, necessitating a return trip to the multifunction device to print new or rescan assessments or add additional sheets during an already narrow window of free time.

There is thus a need for an improved message routing system that can communicate with the teacher or others via a variety of selectable communication devices to enable the teacher to remedy some problems while still at the MFD or away from the teacher's classroom computer. There is a need for a system that would permit the teacher to provide selectable contact and communication preferences so that important communications can be particularly routed to any of the contact preferences depending upon the message and the particular job status.

### SUMMARY

The present embodiment proposes a method and system enabling the ability to use a number of alternative teacher's contact information and addresses for reporting on a specific scan or print job at the MFD. The teacher's nominal contact information is already stored in the system and the present embodiments add an option for the teacher to provide their preferred and alternative contact information so that depending on the message, the time of day and the teacher's location, job status and error messages can be selectively routed. For instance, a teacher could receive a phone text with a “Job Complete” message for a successfully completed print job, or an error message could be received to notify the teacher that there was a problem with a scan or print job from the MFD due to a variety of reasons, such as a miss-scan, missing student assessments from the job, or a need to add paper before an assessment print job can be completed. The teacher would receive the message and be able to act upon it in a manner that best fits the time and conditions. A teacher may decide to walk back to the MFD to resolve the situation right away, or call a secretary or teacher's aide for assistance, or simply retrieve the missing assessment from the student and resolve the problem at the MFD. Alternatively, the aide may directly receive the communication. The device could also accept preset actions for particular conditions, communicating the new status to the teacher once the scan or print job is complete.

The disclosed embodiments include a selectively settable message routing system for communicating a job message associated with an assigned job on a multifunction device (MFD) to an MFD administrator (e.g., teacher, secretary or aide), wherein the job message comprises a job status. The system includes an administrator profile including a plurality of addressable message receiving devices for selective contact of the MFD administrator to communicate a job message. A message routing processor recognizes the job status relative to a set of predetermined factors corresponding to a stall or stoppage of workflow for the assigned job, wherein the processor routes the job message to selected ones of the message receiving devices in response to the recognized ones of the predetermined factors.

In accordance with other aspects of the present embodiments, a message routing system is provided for communicating a selective message from an MFD to a selected MFD administrator indicative of a necessary MFD administrator action. The system includes a primary interface for the MFD for receiving a communication reporting a status of assigned jobs to the MFD by the administrator, wherein the status includes a necessary MFD administrator action. A secondary user interface alternatively receives the communication. A message routing processor associates the necessary MFD administrator action relative to a schedule of weighting factors and selectively reroutes the communication from the primary interface to the secondary interface when the association indicates that the rerouting is appropriate for expediting implementation of the necessary MFD administration actions.

In accordance with the further aspects of the present embodiments, a method is provided for delivering a message representing a status of an MFD device job to an administrator of the MFD via selected ones of a plurality of administrator communication devices. The method comprises associating the status relative to a set of predetermined factors representing an urgency of administrator action for completing the MFD device job. An administrator profile is referenced, listing the administrator communication devices and administrator active hours. The message is delivered to a selected one of the communication devices determined by the associating and the referencing to report the status for expediting and implementing the administrator action.

### BRIEF DESCRIPTION OF THE DRAWINGS

FIG. 1 is pictorial diagram of the general method flow of routing messages in the present embodiments;

FIG. 2 is a set of flowcharts for several different message routings;

FIGS. 3A and 3B are more detailed flowcharts of priority message routing to a teacher;

FIG. 4 is a flow chart of a check assessment priority message routing;

FIG. 5 is a flowchart of a priority message to a student's teacher routing;

FIG. 6 is a screen shot of an exemplary administrative profile to facilitate MFD messaging contact for an administrator/teacher;

FIG. 7 is a screen shot of an exemplary message to an MFD administrator/teacher; and

FIG. 8 is a diagram of the general configuration of the system architecture of the present embodiments.

### DETAILED DESCRIPTION

The subject embodiments particularly relate to an ability to use an administrator's (e.g., teacher's) contact information for a specific scanning or printing job at an MFD to selectively route job status communications. The teacher's collectively alternative contact information is already stored by the teacher in the system control memory. By adding an option for the teacher to provide her preferred contact information for receiving the MFD job status and error messages, the messages can be selectively routed for enhanced efficiency of communication. For instance, a teacher could receive a phone text with a “job complete” message for a successfully completed print job, or an error message could be received to notify the teacher that there was a problem with a scan or print job from the MFD due to a variety of reasons, such as a mis-scan, missing student assessments from the job, or a need to add paper before an assessment print job can be completed. The teacher would receive the message and be able to act upon it in a manner that best fits the times and conditions for job completion. The teacher may decide to walk back to the MFD to resolve the situation right away, or call a secretary or teacher's aide for assistance, or simply remove the assessment for the student and resolve the problem at the MFD. The device could also accept preset actions for particular conditions, communicating a new status to the teacher once the scanner print job is completed. Thus, job status messages can be routed to a system user interface, various email accounts that can be received at a desktop, smartphones or the like, or text messages received via smartphone depending on the job status, time of day, availability of the teacher, or other relevant factors. For some jobs messages, the routing can be to an administrative assistant with greater availability to address the situation reported in the message.

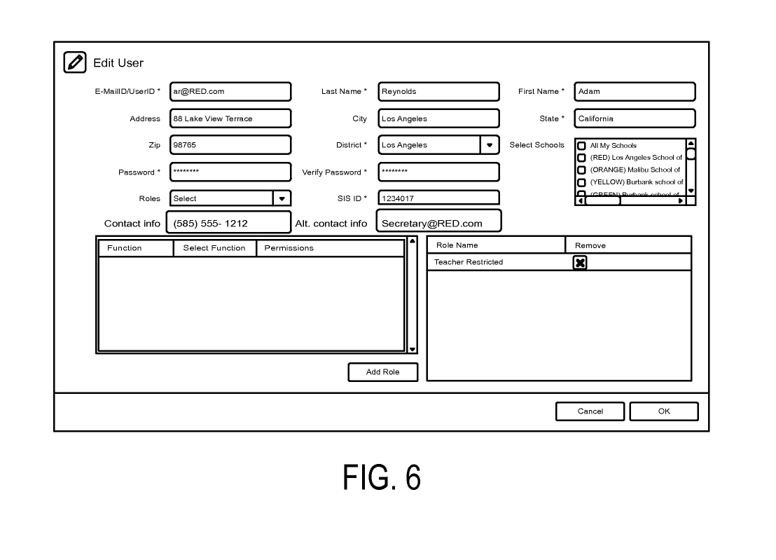

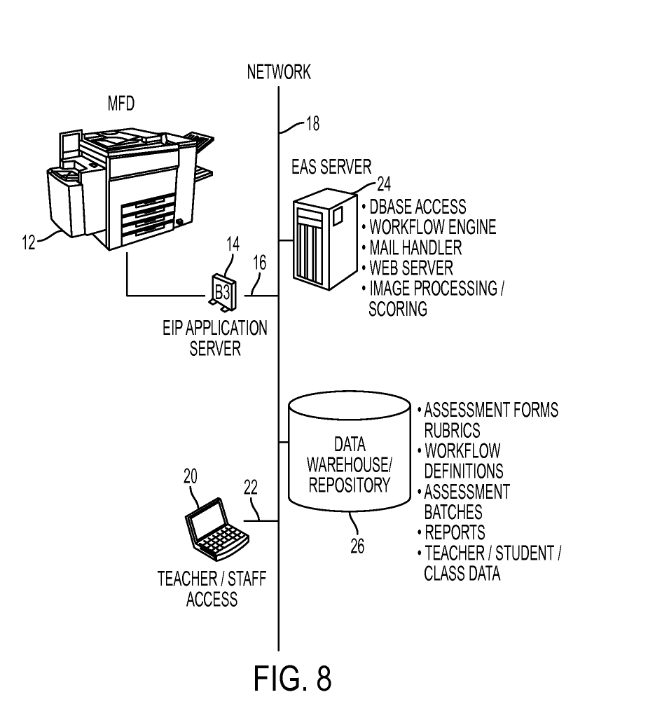

With reference to FIG. 8, a representative architecture of a typical system employed within the present embodiments is illustrated pictorially with the MFD 12 connected through an application server 14 along line 16 to a network 18 which may be either a local or wide area network and may include connections to the internet. The MFD will conventionally include a GUI (not shown). A remote terminal or PC 20 such as a teacher/administrator access terminal is connected along the line 22 to the network 18. This terminal is typically located in the classroom. A system server 24 is also connected to the network 18 and provides the functions of database access such as a workflow engine, mail handler, web server and functions of image processing/assessment review and scoring. A data warehouse/repository 26 is also connected to the network 18 and contains such items as assessment forms and associated rubrics, workflow definitions, assessment batch records, reports, and teacher/student/class data and is operable to receive updates and to provide for access to data stored therein, remotely therefrom over the network 18. In particular relevance to the subject embodiments, the repository 26 also includes a teacher profile and selective contact information for the selective routing of messages to the teacher and alternative destinations in accordance with identification of the particular message and other relevant conditions. Such teacher contact preferences can be entered through data terminal 20 with a user interface that is exemplified in FIG. 6. User information can be entered into the system through the identified blocks therein that identify the teacher via contact information such as email and telephone, as well as alternative contact information such as an administrative assistant or secretary. The data can be password protected.

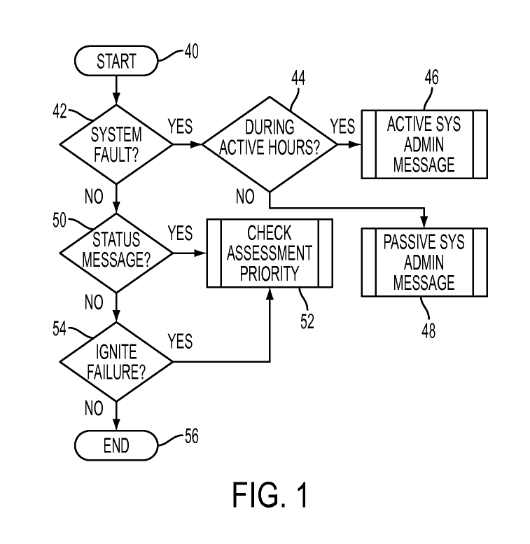

With particular reference to FIG. 1, a general flowchart for the operation of the disclosed embodiments is shown. When the MFD 12 is performing a typical job such as scanning, assessing or printing, represented by start 40, a system fault 42 may occur. If the fault occurs relative to the primary contact administrator i.e., the teacher, running the job, and if it occurs during the active hours 44 a job status message is communicated to the administrator through the active system administrative message protocol 46. If the system fault occurs during non-active hours, the message is routed to the administrator through the passive system administrative message protocol 48. If there is no system fault, then the job progresses as specified by the administrator until a circumstance occurs requiring the sending of a status message 50, triggering a check assessment priority protocol 52 for the appropriate routing and communication of the status message. If there is no requirement of a status message to be sent during the performance of the job, then the only further circumstance requiring a message routing would be a failure of the job performance by the operating system, i.e., “Ignite™ failure” 54 which would again require an assessment check with message routing priority protocol 52 to get the appropriate message to the system administrator. If there is no requirement for reporting of a system fault, a status message or an operating program failure, the job is properly performed and completed 56.

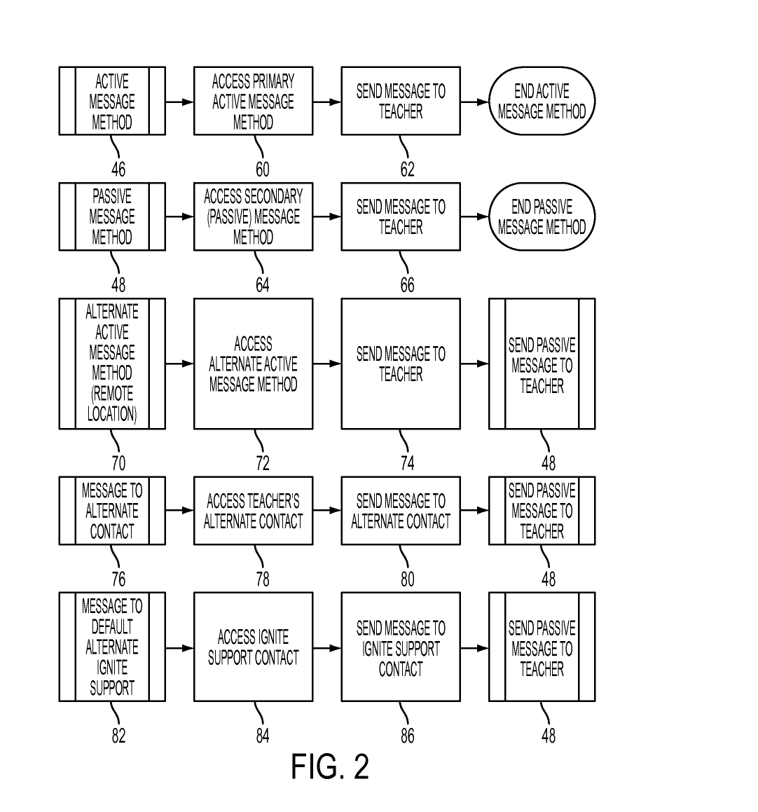

FIG. 2 shows exemplary embodiments of alternative message protocols. The active method protocol 46 occurs when the teacher is to be contacted during active hours 44 as determined in the contact profile FIG. 6 [not shown therein]. The active message method protocol 46 is accessed 60 from the profile and the message is sent 62 to the teacher through a primary contact preference e.g., a teacher email account. If it is determined that a passive system administrator message protocol 48 is to be employed, then similarly, the teacher contact profile is accessed to identify the secondary (passive) message method 64 and then the message is then sent 66 to teacher via method 64. Such a secondary message method may be specified in the profile (FIG. 6) to be routing of the text message to the teacher's cellphone.

Yet another messaging protocol is the alternate active message method (remote location) protocol 70 which involves accessing 72 the alternate active message method (e.g. an alternate email address for the teacher/administrator) and the message is then sent 74 via the passive message method 48.

As will be explained in more detail below, how a message is to be sent includes message identification and weighting for determination that the message is best routed to an alternate contact from the primary contact method. For example, if the message is that the MFD is merely out of paper, rather than being routed to the teacher, a nearby administrative assistant can be contacted. In the message to alternate contact protocol 76, the contact profiles (FIG. 6) will include a teacher's alternate contact that can be accessed via the profile data for the alternate contact and the message can be then sent 82 to that contact.

Yet another message protocol is a message to default alternate Ignite™ support protocol 82 when it is determined that the job status message is the kind that needs to be handled by someone more apt to respond to tech support because it requires system support problem recognition and a resolution. Such alternate Ignite™ support would typically comprise a serviceman or software specialist. The access Ignite™ support contact protocol is also included in the system contact information where it can be accessed 84 so that the appropriate message can be sent 86 and the teacher also informed via the passive message method 48.

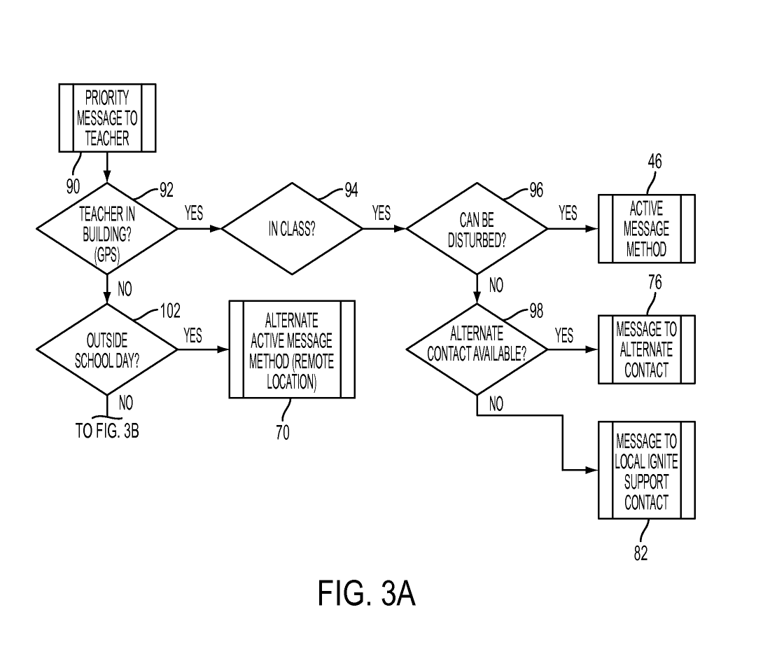

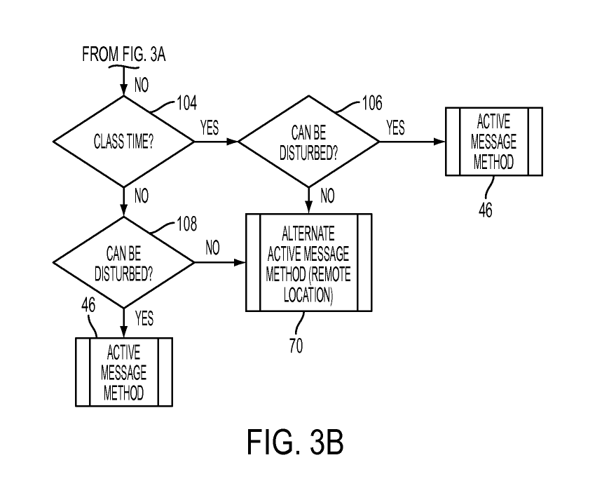

With particular reference to FIGS. 3A and 3B, a more detailed illustration of an embodiment for sending a priority message protocol 90 is shown. Such a priority message would typically entail a message that the job being performed by the MFD and requires the teacher's immediate attention. In this protocol the first inquiry is whether the teacher is in the building 92. Not only the teacher profile, but a GPS signal can be accessed to determine if the teacher is in the building. If so, is the teacher in class 94 and can she be disturbed 96? If the answers to these questions are yes, then the active message method protocol 46 is implemented. If the teacher cannot be disturbed, then the profile will assess whether or not an alternate contact is available 98 and if so, the message is routed to the alternate contact through the alternate contact protocol 76. If the alternate contact is not available, then the message is routed through the local Ignite™ support contact protocol 82. If the teacher is not in the building because it is outside of the school day 102, then the alternate active message method protocol 70 is implemented. If it is determined that the teacher is not in the building but the message occurs in other than an outside school day, then the teacher profile is again checked for class time 104 to determine if the teacher can be disturbed 106 and if so, then again the active method protocol 46 is implemented. If the teacher cannot be disturbed, then the alternate active message method (remote location) protocol 70 is implemented. The alternate active message method protocol 70 is also implemented if the profile determines that the teacher cannot be disturbed 108 even though she is not in class time. If she is not in class time and can be disturbed, the active message method protocol 46 is implemented.

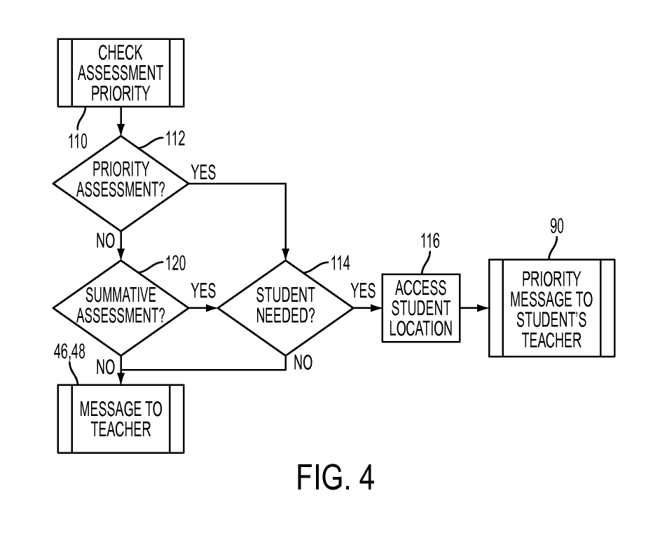

With particular attention to FIG. 4, a method protocol for check assessment/test priority 110 for an MFD scanning/assessing job is illustrated if this protocol applies when an assessment (e.g. student test) is not present in the job being scored by the assessment system. If the assessment is a priority assessment 112 so that the student is needed 114 to complete the assessment, then the student's location must be accessed and a priority message needs to be sent to the teacher to engage the student for completion of the assessment through a priority message protocol to the student's teacher 90 as shown in FIG. 3. Such a priority message protocol may be the active message method 46 or the passive message method 48. Alternatively, the assessment may not be a priority assessment but may be a summative assessment 120 in which case the student would also be needed 114 so that the student must be located 116 and a priority message sent to the teacher 118. Where the student is not needed 114 for the summative assessment 120 then a non-priority message to the teacher can be implemented such as by the active message method 46 or the passive message method 48.

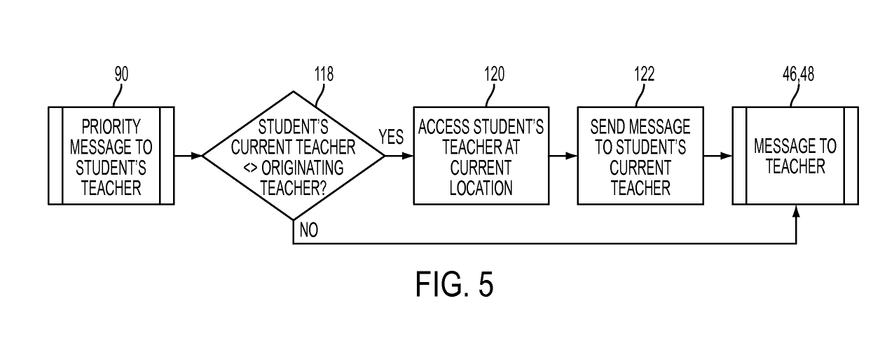

FIG. 5 shows a flowchart of a priority message to the student's teacher protocol when the student's teacher is not the MFD job originating teacher, i.e., is a student's current teacher e.g. the student is in a different classroom from the originating teacher. If the job being conducted is one in which a message needs to be sent to a current teacher, as opposed to the originating teacher for the assessment 118, then the student's current teacher at a current location needs to be identified and a message can be routed 122 to the student's current teacher location in a protocol comprising either the active or passive message methods 46, 48. If there is no current teacher available to handle the priority message, then the originating teacher is similarly contacted through messages 46, 48.

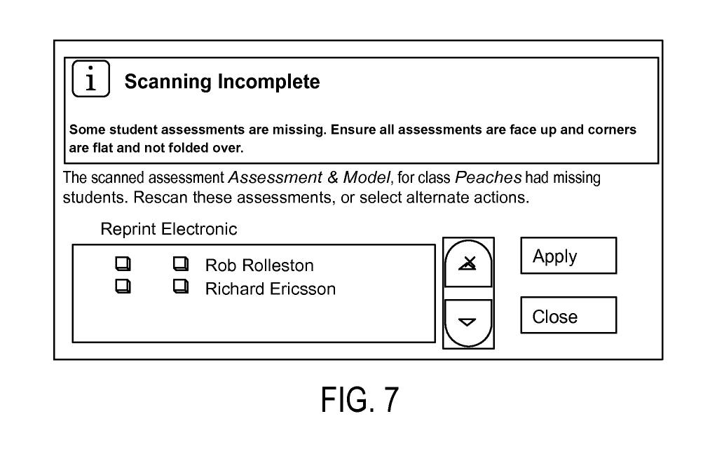

With particular reference to FIG. 7, a typical message routed to a teacher is shown wherein missing students are identified for an assessment job. In this case, students are identified that were missing from the class scanned assessment set and the routing message must communicate the student names that were missing. In the message of FIG. 7, two students were identified and the teacher has several available options to communicate with the assessment system. The message method of FIG. 7 can be sent to the teacher via any of the routing message methods (e.g., terminal, phone, or otherwise) detailed above. In this case, the message of FIG. 7 particularly provides options available to the teacher, and would be similar to those displayed on the user interface of the MFD. The teacher may acknowledge that a student's sheets exist but were not in the stack to be assessed. Usually, the teacher will know that the student's took the assessment but that the sheets were available either with the student or on teacher's desk. The teacher can acknowledge the message and rescan the sheets at a later time. Alternatively, the assessment sheets can be reprinted. In this case, either the student was absent or the student took the assessment and the assessment is not scannable for a variety of reasons. A blank assessment will be reprinted to the MFD for the student to retake. Alternatively, there can be an electronic copy, in which case the student will see the assessment electronically. The student may need to retake the assessment, so the teacher forwards the assessment electronically to the student to be taken online or on a tablet.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

What is claimed is:

1. A selectively settable message routing system for communicating a job message associated with an assigned job on a multifunction device (MFD) to a MFD administrator, wherein the job message comprises a job status, comprising:
an administrator profile including a plurality of addressable message receiving devices for selective contact of the MFD administrator to communicate the job message;
a message routing processor for recognizing the job status relative to a set of predetermined factors corresponding to a stall or stoppage of workflow for the assigned job, wherein the processor routes the job message to selected ones of the message receiving devices in response to the recognized ones of the predetermined factors.

2. The message routing system of claim 1 wherein the job status indicates a necessary administrator action for completing the assigned job.

3. The system of claim 2 wherein a selected one of the message receiving devices is identified in the device administrator profile for direct and timely communicating of the job status.

4. The system of claim 1 wherein the addressable message receiving devices comprise an administrator email reader, a text receiving phone and a user interface of the MFD.

5. The system of claim 1 wherein the device user profile includes redirection message receiving devices for alternative device administrators.

6. The system of claim 1 wherein the device administrator profile includes a time schedule of device administrator active hours.

7. The system of claim 6 wherein the addressable message receiving devices include an active system administrator device and a passive system administrator device.

8. The system of claim 7 wherein the processor communicates the job message to an active system administrator device during the administrator active hours.

9. The system of claim 8 wherein the processor communicates the job message to a passive system administrator device during administrator non-active hours.

10. A message routing system for communicating a selected message from a multifunction device (MFD) to a selected MFD administrator indicative of a necessary MFD administrator action comprising:
a primary interface for the MFD for receiving a communication reporting a status of assigned jobs to the MFD by the administrator; wherein the status includes the necessary MFD administrator action;
a secondary user interface for alternatively receiving the communication; and,
a message routing processor for associating the necessary MFD administrator action relative to a schedule of weighting factors and for selectively rerouting the communication from the primary interface to the secondary interface when the association indicates that the rerouting is appropriate for expedited implementation of the necessary MFD administrator action.

11. The message routing system of claim 10 further including an administrator profile including the primary interface and secondary interface.

12. The message routing system of claim 11 wherein the administrator profile includes a time schedule of administrator active hours for the MFD administrator.

13. The message routing system of claim 12 wherein the secondary interface on active administrator device and the message routing processor routes the communication to the active administrator device during the administrator active hours.

14. The message routing system of claim 12 wherein the primary interface is a passive administrator device and the message routing processor routes the communication to the passive administrator device at times outside of the administrator active hours.

15. The message routing system of claim 12 wherein the administrator comprises a teacher, the assigned job comprises scanning of assessments by the MFD, the primary interface comprises an email display and the secondary interface comprises a text receiving phone.

16. A method for delivering a message representing a status of an MFD device job to an administrator of the MFD via selected ones of a plurality of administrator communication devices comprising:
associating the status relative to a set of predetermined factors representing an urgency of administrator action for completing the MFD device job;
referencing an administrator profile listing the administrator communication devices and administrator active hours; and
delivering the message to a selected one of the communication devices determined by the associating and the referencing to report the status for implementing the administrator action.

17. The method of claim 16 wherein the administrator communication devices include an active message communicator device and a passive message communication device, and the delivery is to the active message communication device during the administrator active hours.

18. The method of claim 17 wherein the delivering is to the passive message communication device outside of the administrator active hours.
